(19) United States
(12) Patent Application Publication
(10) Pub. No.: US 2005/0091281 A1
(43) Pub. Date: Apr. 28, 2005

(54) System and method for limiting multiple downloads of data

(76) Inventors: Chung-I Lee, Tu-Chen (TW); Floye (Hai-Hong) Lin, Shenzhen (CN); Yao Hai Yi, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/973,553

(22) Filed: Oct. 25, 2004

(30) Foreign Application Priority Data
Oct. 24, 2003 (TW) 92129554

(51) Int. Cl. G06F 7/00

(52) U.S. Cl. 707/104.1

(57) ABSTRACT

A system for limiting multiple downloads of data includes a server (1), a database (3), and a plurality of user computers (2). The server includes a plurality of function modules for limiting data download times by predetermining download running totals for documents. The database stores information, document IDs, download ceilings and download running totals of the documents. Each user computer providing a user interface for users to read, download, write, edit and print information. A related method for limiting multiple downloads of data is also disclosed

### BACKGROUND OF THE INVENTION

1. Field of the Invention

The present invention relates to computer downloading technology, and particularly to a system and method for limiting the number of times that data can be download via an electronic network.

2. Background of the Invention

Countless users search, browse and download information through networks, including over the Internet using a web browser. Users also transmit much information through networks for sharing with others. One problem with these information highways is how to prevent excessive downloading of the same information. This can be particularly important for protection of writers' copyrights.

Systems for managing downloads of information are disclosed in a number of patents. For example, Taiwan Pat. Issue No. 497,056 issued on Oct. 1, 2002 and entitled “Method for Paying Writers' Monetary Reward According to Downloaded and Read Times of Articles Through A Network” discloses a method for managing downloading of information. Authors and writers transmit articles through a network. Users can download information from the articles by setting download conditions. The method includes a software unit for calculating writers' remuneration. Network operators calculate each writer's remuneration using the software unit, and arrange for a corresponding payment to be made to the writer. The method can be used to manage downloads of information, but cannot be used to protect the information.

### SUMMARY OF THE INVENTION

Accordingly, a main objective of the present invention is to provide a system and method for limiting multiple downloads of data which can selectively protect various data from being downloaded too much.

To accomplish the above objective, a preferred embodiment of a system for limiting multiple downloads of data of the present invention comprises a server, a database and a plurality of user computers. The server comprises: an information arranging module for arranging information in a database, and for generating a plurality of separate documents according to user needs and/or interrelations among the information; an identification setting module for setting an ID for each of said documents; a download ceiling setting module for setting download ceilings for said documents; a document identification transmitting module for transmitting the document identifications to the user computers; a download running total initializing module for initializing download running totals of said documents to zero; a download running total checking module for checking whether the download running total of a document is equal to or exceeds its download ceiling; a download running total controlling module for adding one to a value of a download running total of a document after each occasion said document is downloaded; and a document download determining module for determining whether the user needs to download other documents, and whether there are requests for downloading documents from other users. The database is connected with the server for storing information, the document IDs, the download ceilings and the download running totals of said documents generated in the above-described processes. Each user computer provides an interactive user interface for users to read, download, write, edit and print information.

Further, a preferred method of the present invention for limiting multiple downloads of data comprises the steps of: (a) arranging information in a database, and generating a plurality of separate documents; (b) setting an ID for each of said documents; (c) setting download ceilings for said documents; (d) initializing download running totals for said documents to zero; (e) receiving a request for downloading one or more of said documents from a user; (f) transmitting one or more corresponding document identifications to a computer of the user; (g) checking whether a download running total of a document to be downloaded is equal to or exceeds the download ceiling of said document, and downloading said document if the download running total of said document is less than the download ceiling; (h) adding one to a value of the download running total of said document; and (i) determining whether the user needs to download any other one or more of said documents, and determining whether there are any one or more requests for downloading one or more of said documents from any other one or more users if the user does not need to download any other one or more of said documents.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware infrastructure of a system for limiting multiple downloads of data in accordance with the preferred embodiment of the present invention;

FIG. 2 is a schematic diagram of main function modules of a server of the system of FIG. 1;

FIG. 3 is a schematic diagram of data flow of the system of FIG. 1; and

FIG. 4 is a flowchart of a preferred method for implementing the system for limiting multiple downloads of data.

### DETAILED DESCRIPTION OF THE INVENTION

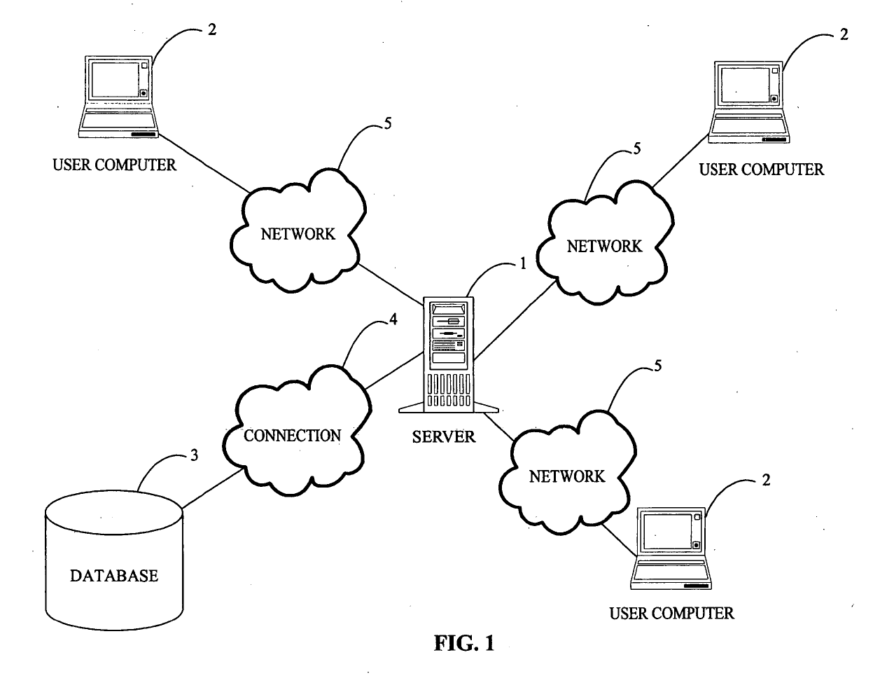

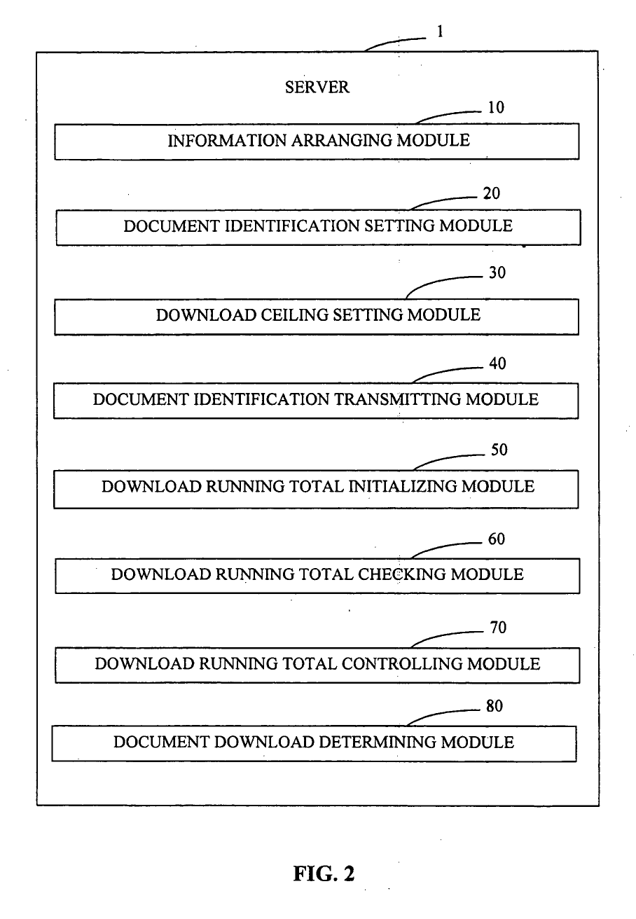

FIG. 1 is a schematic diagram of hardware infrastructure of a system for limiting multiple downloads of data in accordance with the preferred embodiment of the present invention. The system comprises a server 1, a database 3, and a plurality of user computers 2. The server 1 is connected with the database 3 via a connection 4. The connection 4 is a database connectivity such as an Open Database Connectivity (ODBC) or a Java Database Connectivity (JDBC). The server 1 comprises a plurality of function modules (described in detail below in relation to FIG. 2) for managing downloaded electronic documents. The database 3 stores information, document IDs, download ceilings of documents, and running totals of downloads of documents. The user computers 2 are connected with the server 1 through a network 5. The network 5 may be any suitable communication architecture required by the system, such as an intranet or the Internet. Each user computer 2 provides an interactive user interface for users to read, download, write, edit and print information.

FIG. 2 is a schematic diagram of main function modules of the server 1. The server 1 comprises an information arranging module 10, a document identification setting module 20, a download ceiling setting module 30, a document identification transmitting module 40, a download running total initializing module 50, a download running total checking module 60, a download running total controlling module 70, and a document download determining module 80.

The information arranging module 10 is for arranging information in the database 3, and generating a plurality of separate documents according to user needs and/or interrelationships among the information. Each document includes one or more relevant electronic files.

The document identification setting module 20 is for setting an ID for each document. The document ID corresponds to a download address of the document, and is used to download the document.

The download ceiling setting module 30 is for setting download ceilings for the documents. A download ceiling is a maximum number of times that a document can be downloaded. If a document includes more than one file, the download ceiling setting module 30 can also set download ceilings for each file in the document.

The document identification transmitting module 40 is for transmitting document IDs or file IDs to any of the user computers 2.

The download running total initializing module 50 is for initializing download running totals for the documents to zero. A download running total is the number of times that a document has been downloaded up to the present time. If a document includes more than one file, the download running total initializing module 50 initializes a download running total of each file to zero.

The download running total checking module 60 is for checking whether a download running total of a document to be downloaded by a user is equal to or exceeds its download ceiling. If the download running total of the document is equal to or exceeds the download ceiling, the user is prevented from downloading the document. If the download running total of the document is less than the download ceiling, the user is allowed to download the document.

The current download times controlling module 70 is for adding one to a value of a download running total of a document after each occasion the document is downloaded.

The document download determining module 80 is for determining whether the user needs to download other documents, and whether there are requests for downloading documents from other users.

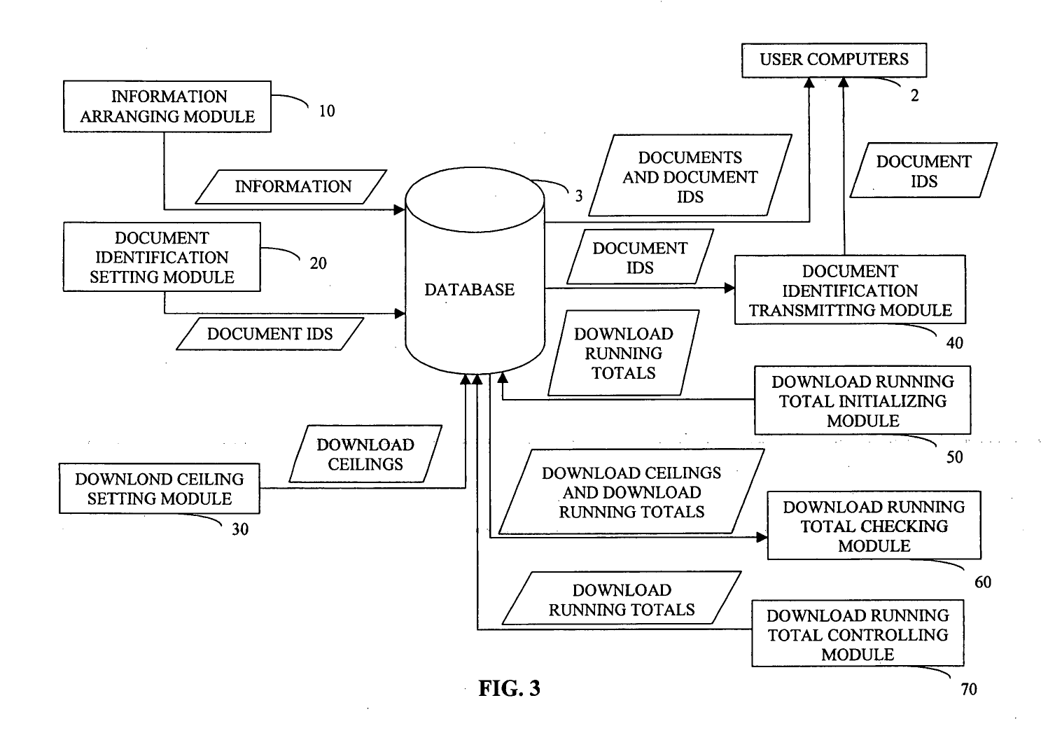

FIG. 3 is a schematic diagram of data flow of the system for limiting multiple downloads of data. The information arranging module 10 arranges information in the database 3, and generates a plurality of separate documents according to user needs and/or interrelationships among the downloaded information. The documents are stored in the database 3. The document identification setting module 20 sets an ID for each document. The document IDs are stored in the database 3. The download ceiling setting module 30 sets download ceilings for all the documents and/or for all files in each document. The download ceilings of the documents/files are stored in the database 3. The download running total initializing module 50 initializes download running totals for the documents and/or for all files in each document to zero. After receiving a request for downloading a document from a user via a user computer 2, the document identification transmitting module 40 obtains a corresponding document ID from the database 3, and transmits the document ID to the user computer 2. When the user computer 2 prepares to download the document, the download running total checking module 60 obtains the download ceiling and download running total of the document, and checks whether the download running total of the document is equal to or exceeds the download ceiling. When the user computer 2 downloads a document from the database 3, it also downloads the corresponding ID of the document. The current download times controlling module 70 adds one to a value of the download running total of the document after the document has been downloaded. The new download running total of the document is stored in the database 3.

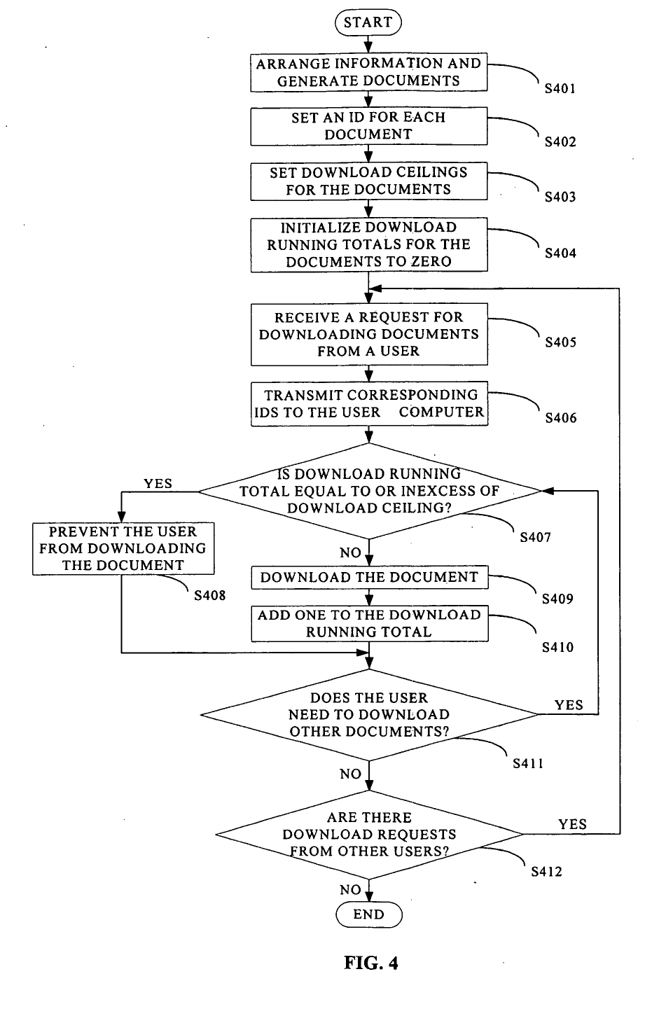

FIG. 4 is a flowchart of a preferred method for implementing the system for limiting multiple downloads of data. In step S401, the information arranging module 10 arranges information in the database 3, and generates a plurality of separate documents. A document may include one or more relevant files. For example, the following seven files S2857030729memo.tif, S2857030729Report.pdf, S2857030115appA.tif, S2857030115appB1.tif, S2857030115appB2.tif, S2857030115appB3.tif and S2857030115appB4.tif may be interrelated in content or in other respects, and can be comprised in a same one document named File0001.xxx. In step S402, the document identification setting module 20 sets an ID for each document. For example, the document identification setting module 20 sets the following ID for the above-described document named File0001.xxx: I2C5N87CB-T0A31-46E77-9041-CR598F2C4E9. In step S403, the download ceiling setting module 30 sets download ceilings for the documents and/or for files in each document. In step S404, the download running total initializing module 50 initializes download running totals of all documents and/or files in each document to zero. In step S405, the server 1 receives a request for downloading documents from a user submitted via a user computer 2. In step S406, the document identification transmitting module 40 obtains corresponding document IDs from the database 3, and transmits the document IDs to the user computer 2. In step S407, the download running total checking module 60 obtains the download ceiling and the download running total of the document from the database 3, and checks whether the download running total of the document is equal to or exceeds the download ceiling. If the download running total of the document is equal to or exceeds the download ceiling, in step S408, the user computer 2 is prevented from downloading the document. If the download running total of the document is less than the download ceiling, in step S409, the user computer 2 is allowed to download the document. The document and the document ID are displayed to the user via a user interface of the user computer 2. In step S410, after the document has been downloaded, the download running total controlling module 70 adds one to a value of the download running total of the document, and stores the new download running total in the database 3. In step S411, the document download determining module 80 determines whether the user needs to download other documents. If the user needs to download other documents, the procedure returns to step S407 described above. If the user does not need to download other documents, the procedure goes to step S412. In step S412, the document download determining module 80 determines whether there are requests for downloading documents from other users. If there are requests for downloading documents from other users, the procedure returns to step S405 described above. If there are no requests for downloading documents from other users, the procedure is ended.

Although the present invention has been specifically described on the basis of a preferred embodiment and a preferred method, the invention is not to be construed as being limited thereto. Various changes and modifications may be made to the embodiment and method without departing from the scope and spirit of the invention.

1. A system for limiting multiple downloads of data, comprising:
a server for managing downloaded documents, the server comprising:
an information arranging module for arranging information in a database, and for generating a plurality of separate documents according to user needs and/or interrelations among the information;
a document identification setting module for setting an identification for each of said documents;
a download ceiling setting module for setting download ceilings for said documents;
a download running total initializing module for initializing download running totals of said documents to zero;
a download running total checking module for checking whether a download running total of a document is equal to or exceeds its download ceiling;
a download running total controlling module for adding one to a value of a download running total of a document after each occasion said document is downloaded; and
a document download determining module for determining whether a user needs to download other documents, and whether there are requests for downloading documents from other users; and
a database storing information, document identifications, download ceilings of documents, and running totals of downloads of documents.

2. The system as described in claim 1, further comprising a plurality of user computers connected with said server through a network, each user computer providing a user interface for users to read, download, write, edit and print information.

3. The system as described in claim 1, wherein each of said documents may include one or more relevant files.

4. The system as described in claim 3, wherein said download ceiling setting module can set a download ceiling of each file in a document.

5. The system as described in claim 3, wherein said download running total initializing module can initialize a download running total of each file in a document to zero.

6. The system as described in claim 2, wherein said server further comprises a document identification transmitting module for transmitting document identifications to said user computers.

7. The system as described in claim 6, wherein each of said document identifications corresponds to a download address of a corresponding document.

8. A method for limiting multiple downloads of data, comprising the steps of:
arranging information in a database, and generating a plurality of separate documents;
setting an identification for each of said documents;
setting download ceiling times for said documents;
initializing download running totals for said documents to zero;
receiving a request for downloading one or more of said documents from a user;
transmitting one or more corresponding document identifications to a computer of the user;
checking whether a download running total of a document to be downloaded is equal to or exceeds the download ceiling of said document, and downloading said document if the download running total of said document is less than the download ceiling;
adding one to a value of the download running total of said document; and
determining whether the user needs to download any other one or more of said documents, and determining whether there are any one or more requests for downloading one or more of said documents from any other one or more users if the user does not need to download any other one or more of said documents.

9. The method as described in claim 8, wherein each of said documents may include one or more files.

10. The method as described in claim 9, wherein the step of setting download ceilings for said documents comprises setting a download ceiling of each file in a document.

11. The method as described in claim 9, wherein the step of initializing download running totals for said documents comprises initializing download running totals for files in one or more said documents to zero.

12. The method as described in claim 8, further comprising the step of preventing the user from downloading said document if the download running total of said document is equal to or exceeds its download ceiling.

13. A method for limiting multiple downloads of data, comprising the steps of:
arranging information in a database, and generating a plurality of separate documents;
setting an identification for each of said documents;
setting a predetermined value of times of a download ceiling for each of said documents disregarding whether downward requests are derived from different users or not;
receiving a downward request for downloading at least one of said documents from a user;
transmitting at least one of the corresponding document identifications to a computer of the user;
downloading said document if a current download running total of said at least one of said documents is less than the download ceiling; and
increasing a value of the current download running total of said at least one of said documents.
